(19) United States
(12) Patent Application Publication
(10) Pub. No.: US 2007/0111648 A1
(43) Pub. Date: May 17, 2007

(54) Artificial vision inspection method and system

(75) Inventors: Philippe Martel, Gatineau (CA); Dominic Paris, St-Alphonse de Granby (CA)

Correspondence Address: AKERMAN SENTERFITT, P.O. BOX 3188, WEST PALM BEACH, FL, 33402-3188, US

(73) Assignee: GROUPE GRB INC., St-Alphonse de Granby (CA)

(21) Appl. No.: 11/488,458

(22) Filed: Jul. 18, 2006

Related U.S. Application Data
(60) Provisional application No. 60/700,020, filed on Jul. 18, 2005.

(51) Int. Cl. A22C 21/06

(52) U.S. Cl. 452/118

(57) ABSTRACT

An artificial vision inspection method and system which takes photographs, on either sides, of poultry or other meat at various stages of processing as they pass by on hanging racks. The method and system then sorts the meat according to quality parameters selected by the user, from presence or absence of parts to size to coloration.

### CROSS-REFERENCE TO RELATED APPLICATION

The present application claims the benefits of U.S. provisional patent application No. 60/700,020 filed Jul. 18, 2005, which is hereby incorporated by reference.

### TECHNICAL FIELD

The present invention relates to an artificial vision inspection method and system. More specifically, the present invention relates to an artificial vision method and system for the inspection of carcasses, for example slaughtered poultry or other meat. The present invention further relates to a method and system for classifying the slaughtered poultry or other meat into predefined categories according to predefined inspection parameters.

### BACKGROUND

The processing of poultry or other meat in a slaughterhouse takes place using different machines, each of which carries out a specific operation on a bird or part of a bird. These machines, which, for example, cut off heads, cut off necks, eviscerate the birds and joint the carcass, are arranged in a logical sequence along conveyor lines, and thus form production lines along which the birds are conveyed, hanging by the two legs from a hook, in order to undergo the successive processing operations.

The poultry supplied to the slaughterhouse is not uniform in body build, weight and/or condition, even if it comes from the same flock (a collection of birds raised together), which means, for example, that variations of up to 20% in the size of body parts may occur between individual birds coming from the same flock or reared under comparable conditions.

On the other hand, a great variety of products is desired by the customers of the slaughterhouse.

In order to make it possible to meet current customer demands in the optimum manner, bifurcations are fitted at certain points on the conveyor lines, which bifurcations are in general formed by automatic overhang machines which are known per se, and where according to the state of the art it is decided on the basis of the weight of each bird and/or on the basis of a visual inspection which conveyance route must be followed from the bifurcation.

It is important here that the most suitable processing should be carried out on the birds on the machine most suitable for that purpose, resulting in the maximum production output. By the known method it is only possible to a very limited extent to guide each bird or part of a bird to the most suitable processing machine, i.e. at a bifurcation in a conveyor line to determine the most suitable path to control an automatic overhang machine, because the means for determining the characteristics of the birds (shape, size of the breast and/or the legs, injuries, condition, etc.) on the basis of which a decision has to be made are non-existent or, in the case of a visual inspection by quality control inspectors, are inadequate having on average a 30 percent margin of error due in particular to the high speeds at which the birds are conveyed along the conveyor line.

### SUMMARY

The present invention relates to a system and method for classifying a meat carcass, implementing the steps of:
a. acquiring at least one digital image of the carcass;
b. processing the digital image;
c. verifying the processed digital image in order to detect the presence of at least one defect;
d. classifying the carcass in response to the presence or not of the at least one defect.

The present invention further relates to a system and method for classifying a meat carcass as described above which activates an output associated with the classification of the carcass effected in step d.

### BRIEF DESCRIPTION OF THE FIGURES

Embodiments of the invention will be described by way of example only with reference to the accompanying drawings, in which:

FIG. 1 is schematic view of an embodiment of the artificial vision inspection system;

FIG. 2 is a flow diagram of a general algorithm for the inspection of slaughtered poultry or other meat;

FIG. 3 is a digital image of a slaughtered poultry;

FIG. 4 is a flow diagram of a general algorithm for the processing of the digital image of a slaughtered poultry;

FIG. 5 is the digital of FIG. 3 after being processed by the algorithm of FIG. 4;

FIG. 6 is a contour view of FIG. 5 to which is applied a leg detection tool;

FIG. 7A and 7B is a flow diagram of an algorithm for detection of a missing wing or a wing drum in a slaughtered poultry;

FIG. 8 is a flow diagram of a first embodiment of an algorithm for the determination of a reference point on the side of a slaughtered poultry;

FIG. 9 is a flow diagram of a second embodiment of an algorithm for the determination of a reference point on the side of a slaughtered poultry;

FIG. 10 is a contour view of FIG. 5 to which is applied a wing detection tool;

FIG. 11 is a contour view of FIG. 5 to which is applied a wing detection tool;

FIG. 12 is a flow diagram of an algorithm for the detection of holes in legs of slaughtered poultry;

FIG. 13 is a contour view of FIG. 5 to which is applied a hole detection tool;

FIG. 14A and 14B is a flow diagram of an algorithm for the detection of a skin condition in slaughtered poultry; and

FIG. 15 is a contour view of FIG. 5 to which is applied a skin condition detection tool.

### DETAILED DESCRIPTION

A non-restrictive illustrative embodiment of the present invention is concerned with artificial vision method and system for the inspection of slaughtered poultry or other meat and for classifying the slaughtered poultry or other meat into predefined categories according to predefined inspection parameters.

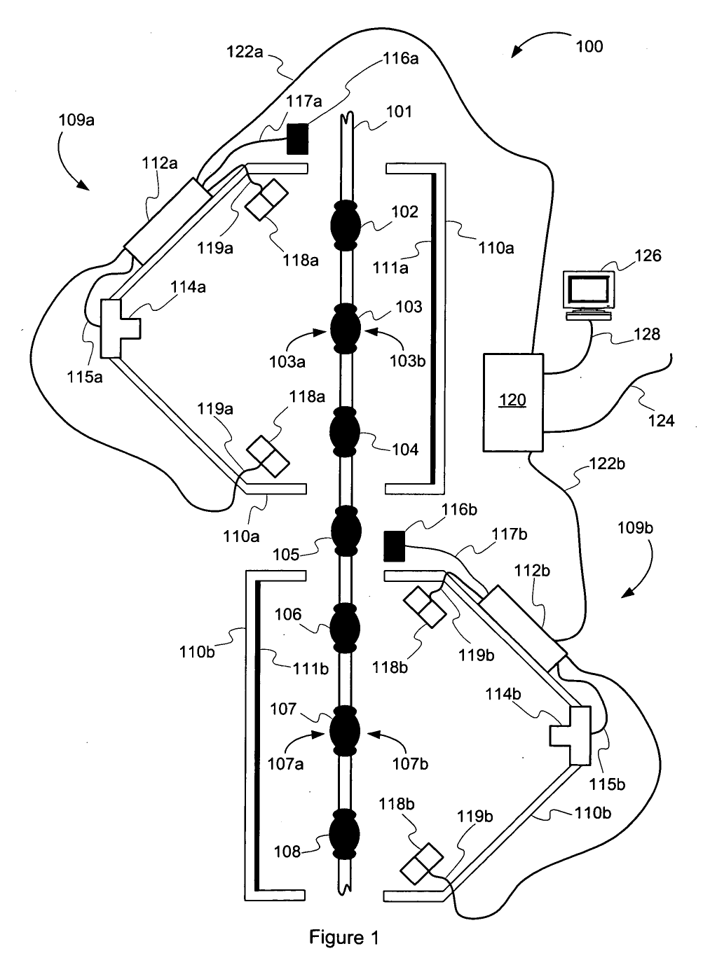

Referring to FIG. 1 of the appended drawings, the artificial vision inspection system 100 includes a conveyor 101 on which, for example, carcasses 102, 103, 104, 105, 106, 107, 108 are conveyed through a front and back inspection stations 109a and 109b, respectively. Each carcass presents for inspection a front portion to the front inspection station 109a and a back portion to the back inspection station 109b. The front inspection station 109a is concerned with the inspection of the front portions of the carcasses 102, 103, 104, 105, 106, 107, 108, for example the front portions 103a and 107a of carcasses 103 and 107, respectively, and the back inspection station 109b with the inspection of the back portion of the carcasses 102, 103, 104, 105, 106, 107, 108, for example 103b and 107b. For the sake of clarity only the front inspection station 109a will be further described but it is to be understood that the back inspection station 109b includes components similar to the components of the front inspection station 109a. The components of the back inspection station 109b are identified by similar numerals as those for the front inspection station 109a but ending with a “b” instead of an “a”.

The front inspection station 109a includes an enclosure 110a, which may be made of, for example, stainless steel, having a non-reflective backdrop 111a, a breakout board 112a and a sensor 116a connected to the breakout board 112a using connector 117a. Within the enclosure 110a are positioned a digital camera 114a and diffuse light sources 118a, which are connected to the breakout board 112a using connector 115a and 119a, respectively. The purpose of the enclosure 110a is to block ambient light so that the carcasses 102, 103, 104, 105, 106, 107, 108 may be uniformly illuminated by the diffuse light sources 118a. As for the backdrop 111a, its purpose is to provide a uniform and contrasting background on which digital images of the carcasses 102, 103, 104, 105, 106, 107, 108 may be taken by the digital camera 114a.

The breakout boards 112a and 112b of the front and back inspection stations 109a and 109b, respectively, are both connected to a main board 120 through connectors 122a and 122b, respectively. In turn, the main board 120 is connected to a sorting station (not shown), through connector 124. The sorting station directs, upon receiving a signal from the main board 120, which path each of the carcass is to take for further processing. Optionally, the main board 120 may be connected to a PC or monitoring station 126, through connector 128. Furthermore, the digital cameras 114a, 114b may also optionally be connected directly to the main board 102 (connector not shown) in order to provide digital images that may be stored for surveillance, further processing, inventory, statistical analysis, etc.

In the illustrative embodiment the breakout board 112a may be a CON-IBOB from DVT, the digital camera 114a a 552 CW from DVT, the sensor 116a an E3Z-T86 photoelectric sensor from Omron and the diffuse light sources 118a IDWA-D strobe lights from DVT.

It is to be understood that the various connectors 115a, 117a, 119a, 122a, 124 and 128 may be any suitable wired or wireless communication technologies.

In operation, whenever a carcass, for example carcass 103, enters the front inspection stations 109a along the conveyor 101 and passes in front of the sensor 116a, the sensor 116a sends a signal to the breakout board 112a, which synchronizes the activation of the digital camera 114a and the light sources 118a in order to acquire a digital image of the front portion 103a of the carcass 103. The camera 114a includes a processor with an inspection algorithm, which will be detailed further below, that analyses the image of the front portion 103a of the carcass 103 and provides classification data to the breakout board 112a, which in turn provides the signal to the main board 120. Similarly, when the carcass, for example carcass 107, enters the back inspection station 109b the same chain of events takes place for the back portion 107b of the carcass 107 and the information is provided to the main board 120. The main board 120 receives classification data from both the front 109a and the back 109b inspection stations, and using that data activates proper bifurcation devices in order to route each of the carcasses 102, 103, 104, 105, 106, 107, 108 on the path corresponding to its classification.

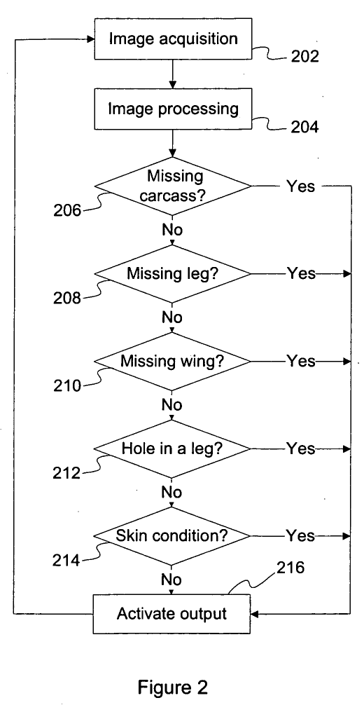

A possible inspection algorithm that may be executed by the processor of the digital camera 114a is depicted by the flow diagram shown in FIG. 2. The steps of the algorithm are indicated by blocks 202 to 216. The algorithm may be in the form of a script using, for example, tools found in the Intellect software from DVT. Thus any reference to “tools” refers to tools present in the Intellect software. It is to be understood that other software with tools having similar functions may be used. Furthermore, although the following description of the algorithm makes reference to the front portion of a carcass, it is to be understood that the algorithm applies to its back portion as well.

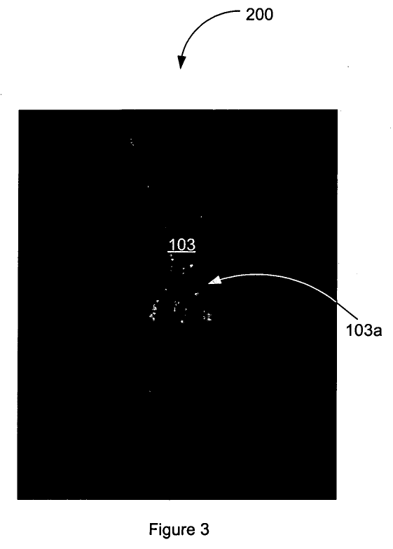

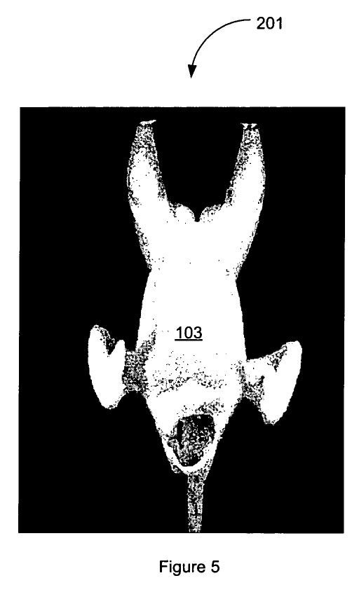

At block 202 the algorithm starts by acquiring the digital image of the carcass, for example a 640 by 480 pixel image 200 of the front portion 103a of carcass 103, such as shown in FIG. 3. The image 200 is acquired each time the breakout board 112a, in synchronization with the sensor 116a, activates the digital camera 114a and associated diffuse light sources 118a. At block 204, the digital image 200 acquired at block 202 is processed to enhance it and provide a high contrast image 201 of the front of the carcass 103a, such as shown in FIG. 5, in order to facilitate the detection of various features. The processing of the acquired digital image 200 into the high contrast image 201 will be detailed further below.

Then, at block 206, the algorithm detects if a carcass is present or not as the sensor 116a may have been activated by the presence of the tip of a wing from a following carcass. If no carcass is detected, the algorithm registers the defect and goes to block 216 to activate the output. If a carcass is detected, for example carcass 103, the algorithm proceeds to block 208.

At block 208, the algorithm detects if the carcass 103 is missing a leg. If a missing leg is detected, the algorithm registers the defect and goes to block 216 to activate the output. If both legs are detected, the algorithm proceeds to block 210.

At block 210, the algorithm detects if the carcass 103 is missing a wing or if a wing drum is present. If a missing wing or a wing drum is detected, the algorithm registers the defect and goes to block 216 to activate the output. If both wings are detected, the algorithm proceeds to block 212.

At block 212, the algorithm detects the presence of a hole in one of the legs of the carcass 103. If a hole is detected, the algorithm registers the defect and goes to block 216 to activate the output. If no holes are detected, the algorithm proceeds to block 214.

At block 214, the algorithm detects the presence of one or more skin condition on the skin of the carcass 103. If a skin condition is detected, the algorithm registers the defect and goes to block 216 to activate the output. If no skin condition is detected, the algorithm proceeds to block 216.

Finally, at block 216, the algorithm classifies the front portion 103a of the carcass 103 as a pass or a fail depending on whether a defect has been detected or not. The digital camera 114a then forwards its classification data to the breakout board 112a which in turn communicates it to the main board 120. The main board 120 having classification data for both the front and back portions of a given carcass may then activate proper bifurcation devices in order to route the carcass on the path corresponding to its classification. The algorithm then goes back to block 202 where a new digital image is acquired.

It is to be understood that although the above described possible inspection algorithm activates the output as soon as a defect is detected, in an alternative embodiment the inspection algorithm may wait until all defects have been detected and activate the output according to a decision making process based on the presence of specific combinations of defects or may even determine a path amongst many paths depending on the detected combinations of defects.

Image Processing

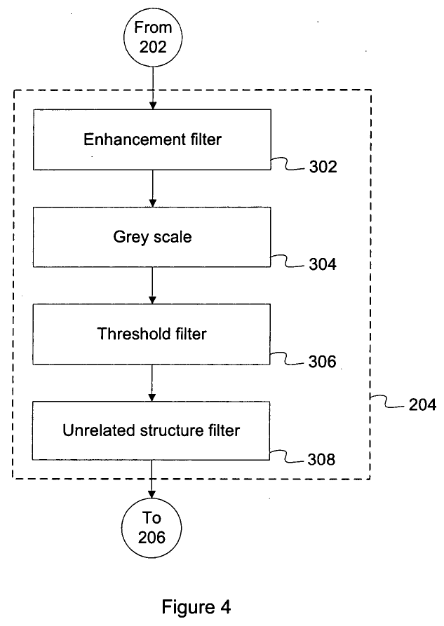

An possible image processing algorithm that may be used, at block 204, to process the digital image 200 to create the high contrast image 201 is depicted by the flow diagram shown in FIG. 4. The steps of the algorithm are indicated by blocks 302 to 308.

The algorithm starts at block 302 by applying an enhancement filter to the digital image 200 using, for example, the “image domain tool” with an RGB gain of 3.6 for the Red and 0 for both the Blue and the Green. This is to accentuate the pixels belonging to the carcass 103 and may vary depending on the type of carcass being inspected. In this specific example the type of carcass being inspected is poultry.

At block 304, the filtered image is transformed into a grayscale image and, at block 306, a threshold filter is applied so as to clarify the image. The “blob” tool with a luminosity threshold of 41% may be used for this purpose. Of course, this threshold may be adjusted depending on the type of carcass, lighting conditions, etc.

Then, at block 308, an unrelated structure filter may be applied in order to retain a representation of the present carcass and exclude any wing parts from neighboring carcasses which may be in the field of view of the digital camera 114a. For that purpose the “minimum size” tool with a value of 50,000 pixels may be applied.

Carcass Detection

The detection of a carcass, which is performed at block 206, may be performed by detecting the presence of at least 50,000 pixels in the high contrast image 201 using, for example, the “pixel counter” tool. This allows for the elimination of part of a wing from a neighboring carcass which may have been in the field of view of the digital camera 114a.

Leg Detection

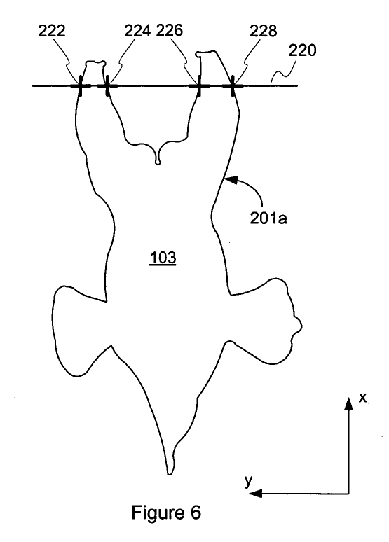

The detection of the presence of one or two legs, which is performed at block 208, may be performed by detecting if there are two or four contrast changes along a line placed across where the legs should be present on the high contrast image 201. FIG. 6 illustrates a schematic view of the contour 201a of the high contrast image 201 on which is placed a line 220 at the 590^{th} pixel in the x axis, the origin of the coordinates being at the bottom right corner of the image. The algorithm uses, for example, the “position along line” tool to detect the contrast changes 222, 224, 226 and 228 along line 220. In this specific case two legs are detected. If only one leg was present the algorithm would have detected only two contrast changes instead of four.

Alternatively, the detection of the presence of one or two legs may be performed by detecting if there is at least one contrast change along each of two lines (not shown) placed across where each of the legs should be present on the high contrast image 201.

Wing Detection

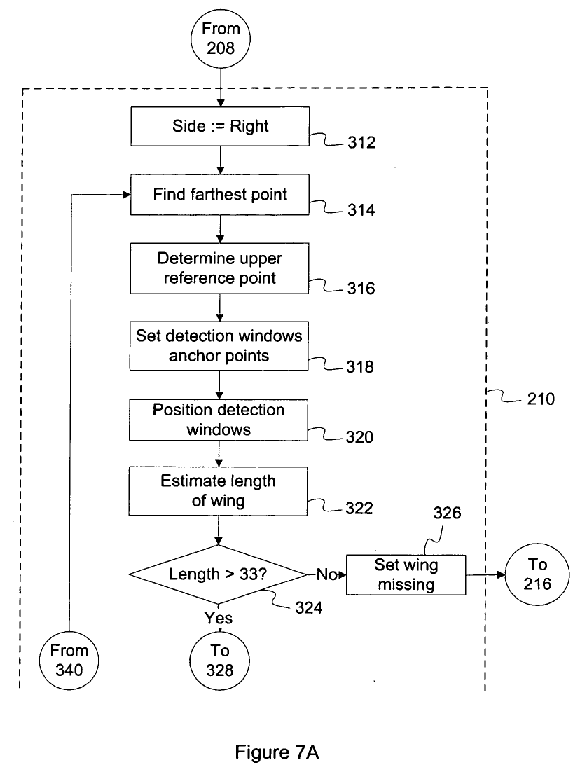

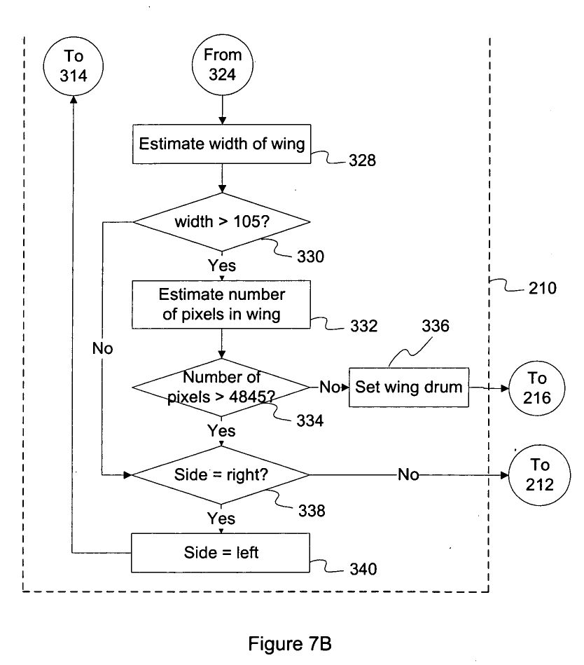

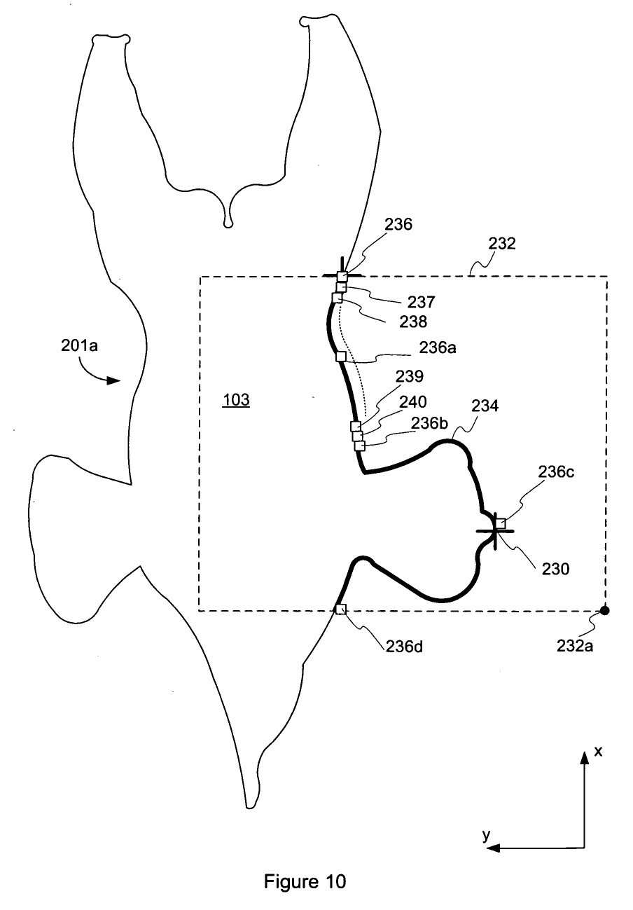

A possible algorithm for the detection of the presence of the wings that may be used at block 210 is depicted by the flow diagram shown in FIGS. 7A and 7B with reference to FIG. 10. The steps of the algorithm are indicated by blocks 312 to 342.

At block 312 the algorithm starts by setting the side of the carcass 103 to be inspected to the right side. Then, at block 314, the farthest point (pixel) 230 from the center of the carcass, e.g. the pixel with the lowest y coordinate value, is identified, as shown in FIG. 10. The “line fit” tool may be used to determine the farthest point 230 along the contour 201 a of the high contrast image 200. It is to be understood that if it were the left side of the carcass that was being inspected that the farthest point would be the one with the highest y axis coordinate value.

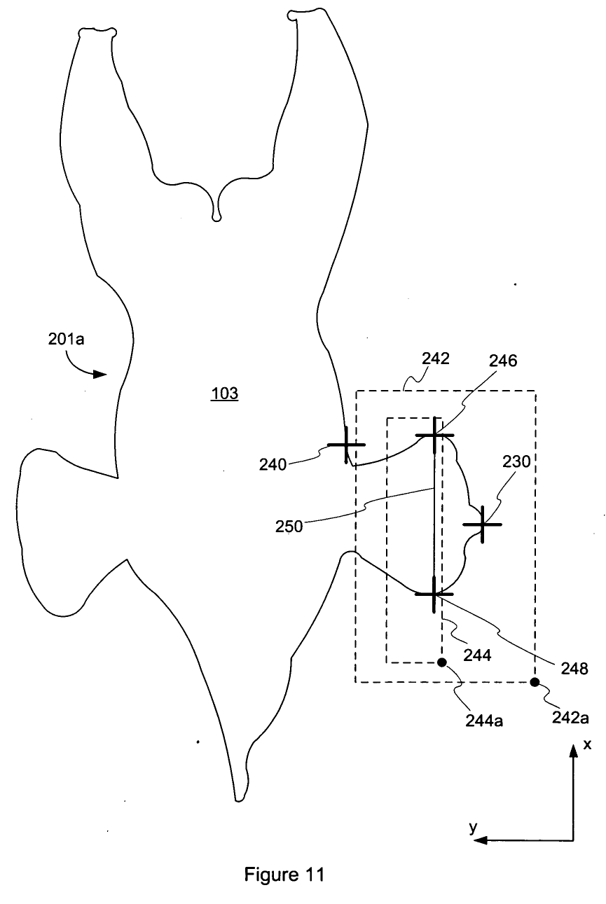

At block 316, the algorithm identifies an upper reference point 240. The algorithm performed to identify the upper reference point 240 will be detailed further below. Using the upper reference point 240 identified at block 316, the algorithm, at block 318, sets detection windows anchor points 242a and 244a, as shown in FIG. 11. The anchor points 242a, 244a may be set using predetermined x and y coordinate offsets. For example, assuming that the upper reference point 240 has coordinates (295, 165), the first offset may be (220, 120) and the second offset (170, 160) resulting in anchor point 242a and 244a, having coordinates (75, 45) and (125, 105), respectively. It is to be understood that these offset values may vary depending on the application and the type of carcass being inspected.

At block 320, the detection windows 242 and 244 are positioned using anchor points 242a and 244a, respectively, as the bottom right corners of rectangles having dimensions of 240 pixels in the x axis, 110 pixels in the y axis, and 185 pixels in the x axis, 40 pixels in the y axis, respectively. It is to be understood that these dimensions may vary depending on the application and the type of carcass being inspected.

At block 322, the length of the wing is estimated by computing the distance between the farthest point 230 and the upper reference point 240. It is to be understood that any other suitable reference points along the contour 201a which are representative of the side of the carcass 103 may be used for the approximation. Then, at block 324 the algorithm verifies if the estimated wing length is greater than 33 pixels. If not, the algorithm goes to block 326 were it registers that a wing is missing and then exits.

At block 328, the width of the wing is estimated by computing the distance 250 between the two farthest points 246, 248 along the contour 201a within detection window 244. The “measure an area” tool may be used to determine distance 250. Then, at block 330 the algorithm verifies if the estimated wing width is greater than 105 pixels. If not, the algorithm goes to block 338.

At block 332, the number of pixels in the wing is estimated by computing the number of pixels within detection window 242. The “pixel counter” tool may be used to determine number of pixels within detection window 242. Then, at block 334 the algorithm verifies if the estimated number of pixels in the wing is greater than 4,845 pixels. If not, the algorithm goes to block 336 were it registers that a wing drum is present instead of a wing and then exits.

At block 338, the algorithm verifies if the left side of the high contrast image 201 has been inspected. If not, at block 340, the algorithm sets the side of the carcass 103 to be inspected to the left side and goes back to block 314. If both sides of the carcass 103 have been inspected, the algorithm exits.

It is to be understood that the example algorithm described above exits as soon as a defect is detected but that in alternative embodiment the algorithm may wait until all defects have been detected before exiting.

Identification of the Upper Reference Point

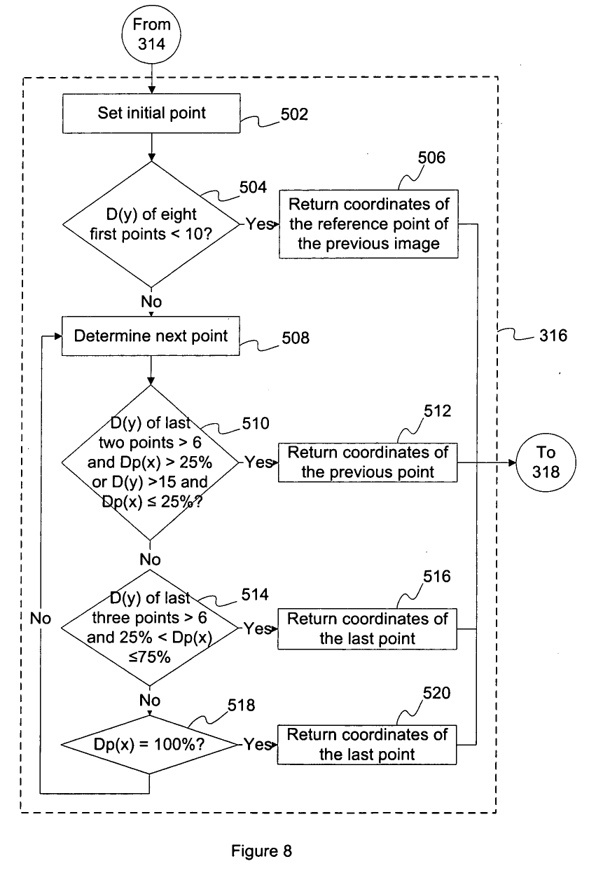

A first embodiment of a possible algorithm for the identification of the upper reference point that may be used at block 316 is depicted by the flow diagram shown in FIG. 8 with reference to FIG. 10. The steps of the algorithm are indicated by blocks 502 to 520.

At block 502 the algorithm starts by setting an initial point 236. This initial point 236 is selected as being the point having the highest x coordinate amongst the point located on a path 234 along the contour 201a of the high contrast image 200 comprised in window 232. The anchor point 232a of window 232 is has coordinates (120, 5) and the window 232 is a rectangle having dimensions of 270 pixels in the x axis, 290 pixels in the y axis.

At block 504, the algorithm verifies if the difference in the y axis coordinates (D(y)) of the first eight points along path 234 is less than 10. If so, the algorithm proceeds to block 506 where the coordinates of the reference point of the previous image are returned and then exits. This step is to help eliminate cases where two adjacent carcasses are in contact or very close proximity. The “line fit” tool may be used to determine the first eight points along path 234.

At block 508, the next point in the decreasing x axis direction along path 234 is determined. For example, the next point after initial point 236 is point 237, and after point 237 is point 238. The “line fit” tool may be used to determine the next point along path 234.

Then, at block 510, the algorithm verifies if the difference in the y axis coordinates (D(y)) of the last two points is higher than 6 and the difference in the x axis coordinates as a ratio of the total x axis distance of path 234 (Dp(x)) of the last point, i.e. the difference in the x axis coordinates between the last point and point 236 divided by the difference in x axis coordinates between point 236d and 236, is greater than 25% (point 236a), which would indicate that the algorithm has reached the beginning of the wing. If so, the algorithm proceeds to block 512 where the coordinates of the previous point are returned.

At block 514, the algorithm verifies if the difference in the y axis coordinates (D(y)) of the last three points is higher than 6 and the difference in the x axis coordinates as a ratio of the total x axis distance of path 234 (Dp(x)) of the last point is greater than 25% (point 236a) and less or equal to 75% (point 236c). If so, the algorithm proceeds to block 516 where the coordinates of the last point are returned.

Finally, at block 518, the algorithm verifies if the difference in the x axis coordinates as a ratio of the total x axis distance of path 234 (Dp(x)) of the last point is equal to 100% (point 236d), i.e. the algorithm has reached the end of path 234. If so, the algorithm proceeds to block 520 where the coordinates of the last point are returned. If not, the algorithm goes back to block 508 to find the next point along path 234.

Basically, the algorithm travels along path 234 until it detects the beginning of the wing, in which case it returns the coordinates of the point just before the start of the wing or the point 236d at the end of path 234 if the beginning of the wing has not been detected yet. For example, of the algorithm had just determined point 240 as the next point, it would verify if the difference in the y axis coordinates of point 240 and point 239 is higher than 6 and the difference in the x axis coordinates as a ratio of the total x axis distance of path 234 (Dp(x)) of point 240 is greater than 25%. If so, then the returned coordinates would be those of point 239. Otherwise, the algorithm would verify if the difference in the y axis coordinates (D(y)) of the last three points is higher than 6 and the difference in the x axis coordinates as a ratio of the total x axis distance of path 234 (Dp(x)) of point 240 is greater than 25% (point 236a) and less or equal to 75% (point 236c). If so, the algorithm would return the coordinates of point 240. Then, the algorithm would verify if the difference in the x axis coordinates as a ratio of the total x axis distance of path 234 (Dp(x)) of point 240 is equal to 100% (point 236d). If so, the algorithm would return the coordinates of point 240, if not, it would go back to block 508 in order to determine the next point along path 234.

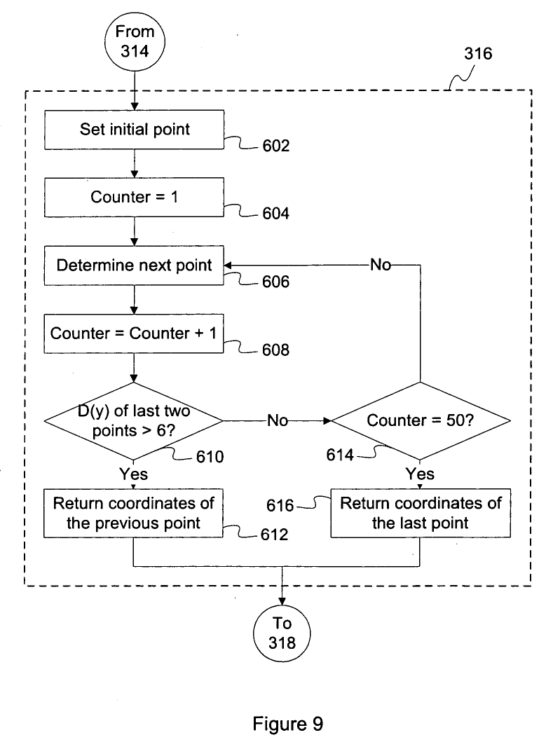

A second embodiment of a possible algorithm for the identification of the upper reference point that may be used at block 316 is depicted by the flow diagram shown in FIG. 9 with reference to FIG. 10. The steps of the algorithm are indicated by blocks 602 to 616.

At block 602 the algorithm starts by setting an initial point 236. This initial point 236 is selected as being the point having the highest x coordinate amongst the point located on a path 234 along the contour 201a of the high contrast image 200 comprised in window 232. The anchor point 232a of window 232 is has coordinates (120, 5) and the window 232 is a rectangle having dimensions of 270 pixels in the x axis, 290 pixels in the y axis.

At block 604 a counter is set to 1 following which, at block 606, the next point in the decreasing x axis direction along path 234 is determined. For example, the next point after initial point 236 is point 237, and after point 237 is point 238. The “line fit” tool may be used to determine the next point along path 234. Once the next point is determined, at block 608, the counter is increased by 1.

Then, at block 610, the algorithm verifies if the difference in the y axis coordinates (D(y)) of the last two points is higher than 6, which would indicate that the algorithm has reached the beginning of the wing. If so, the algorithm proceeds to block 612 where the coordinates of the previous point is returned. However, if the difference in the y axis coordinates (D(y)) of the last two points is not higher than 6, the algorithm proceeds to block 614 where it verifies if the counter has reached 50. If so, the algorithm proceeds to block 616 where the coordinates of the last point is returned. If not, the algorithm goes back to block 606 to find the next point along path 234.

Basically, the algorithm travels along path 234 until it detects the beginning of the wing, in which case it returns the coordinates of the point just before the start of the wing or the value of the 50^{th} point along the path if the beginning of the wing has not been detected yet. For example, if the algorithm had just determined point 240 as the next point, it would verify if the difference in the y axis coordinates (D(y)) of point 240 and point 239 is higher than 6. If it is higher than 6 then the returned coordinates would be those of point 239. On the other hand, if the difference in y axis coordinates was not higher than 6 then the algorithm would verify if point 240 was the 50^{th} point along path 234, by verifying if the counter had reached 50. If so, the algorithm would return the coordinates of point 240, if not, it would go back to block 606 in order to determine the next point along path 234.

Hole Detection

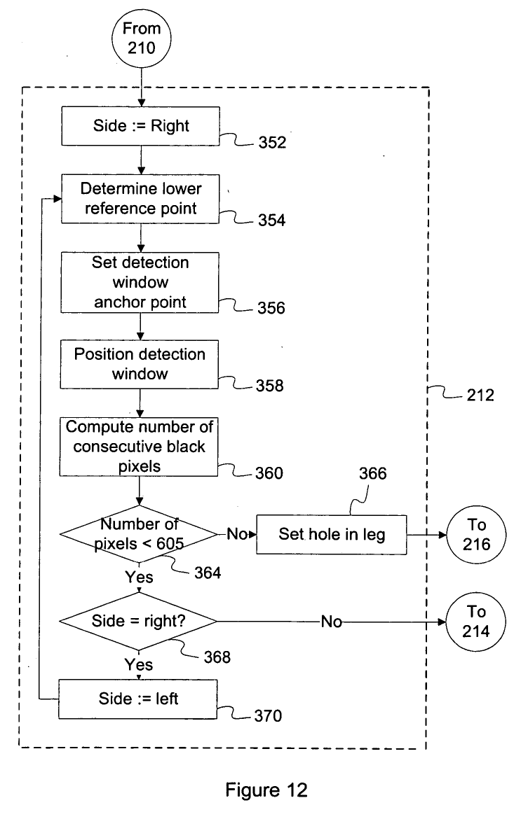

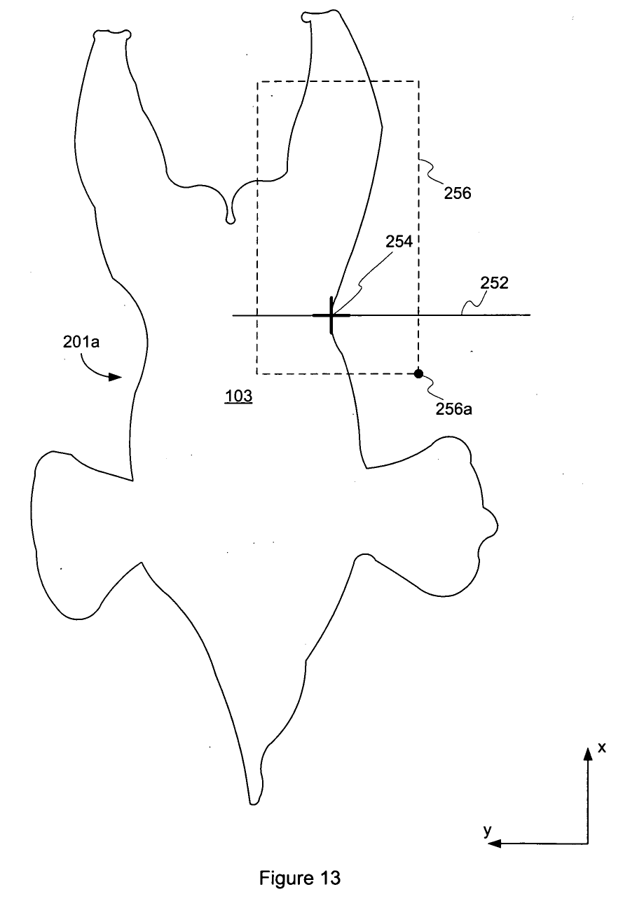

A possible algorithm for the detection of the presence of a hole in one of the legs that may be used at block 212 is depicted by the flow diagram shown in FIG. 12 with reference to FIG. 13. The steps of the algorithm are indicated by blocks 352 to 370.

At block 352 the algorithm starts by setting the side of the carcass 103 to be inspected to the right side. Then, at block 354, a lower reference point 254 is determined. To determine the coordinates of the lower reference point 254 a line 252 is place over the contour 201a of the high contrast image 201 at the 370^{th} pixel in the x axis and the algorithm uses, for example, the “position along line” tool to detect the contrast changes 254 along line 252.

At block 356, using the lower reference point 254 identified at block 354, the algorithm sets a detection window 256 anchor point 256a. The anchor point 256a is set using predetermined x and y coordinate offsets. For example, assuming that the lower reference point 254 has coordinates (370, 160), the offsets may be (35, 55), resulting in anchor point 256a having coordinates (335, 105). It is to be understood that these offset values may vary depending on the application and the type of carcass being inspected.

At block 358, the detection window 256 is positioned using anchor point 256a as the bottom right corner of a rectangle having dimensions of 200 pixels in the x axis, 110 pixels in the y axis. It is to be understood that these dimensions may vary depending on the application and the type of carcass being inspected.

At block 360, the number of consecutive black pixels within detection window 256, but not touching the sides of the detection window 256, is computed. The “pixel counter” tool may be used to determine number of consecutive black pixels within detection window 242. In order to better detect the presence of holes, the “blob” tool may be used with a threshold of 81% before computing the number of consecutive black pixels. This as for effect to set to black any lighter intensity pixels that may represent damage skin around the holes which may isolate black pixels from one another.

Then, at block 364 the algorithm verifies if the computed number of consecutive black pixels is lower is lower than 605 pixels. If not, the algorithm goes to block 366 were it registers that a hole is present in a leg and exits.

Finally, at block 370, the algorithm verifies if the left side of the high contrast image 201a has been inspected. If not, the algorithm sets the side of the carcass 103 to be inspected to the left side and goes back to block 354. If both sides of the carcass 103 have been inspected, the algorithm exits.

Skin Condition Detection

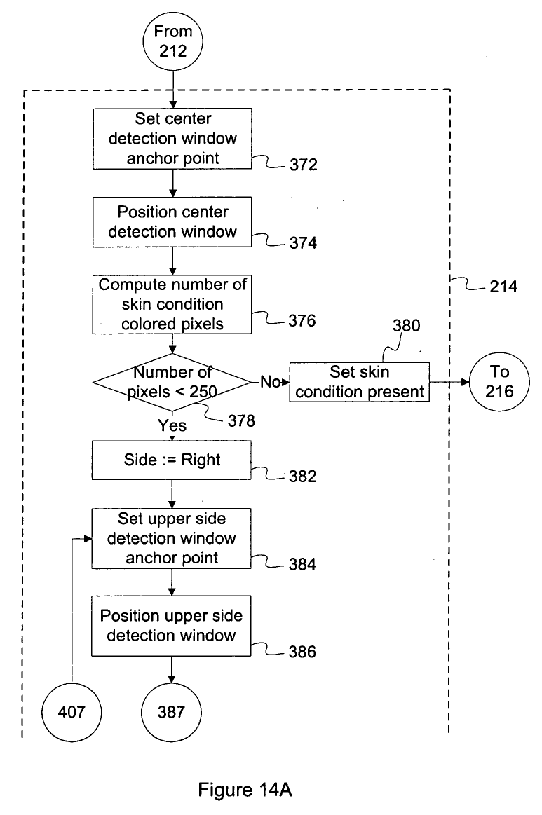

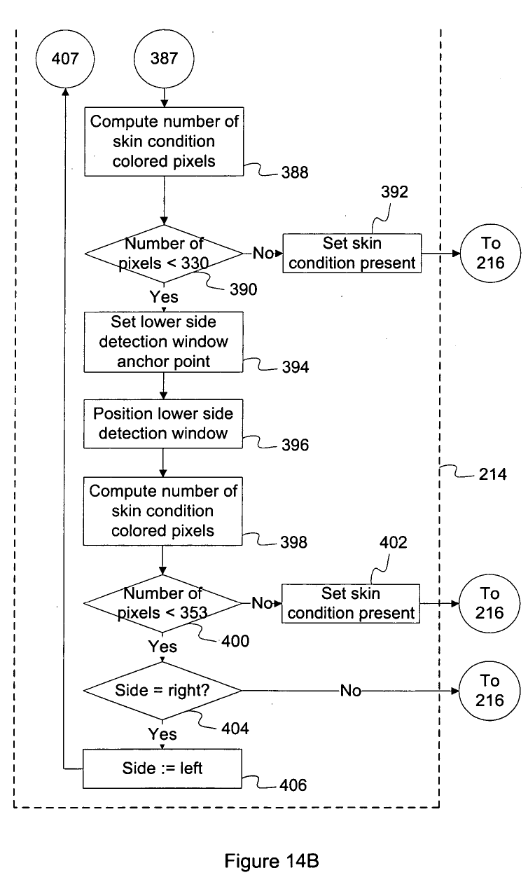

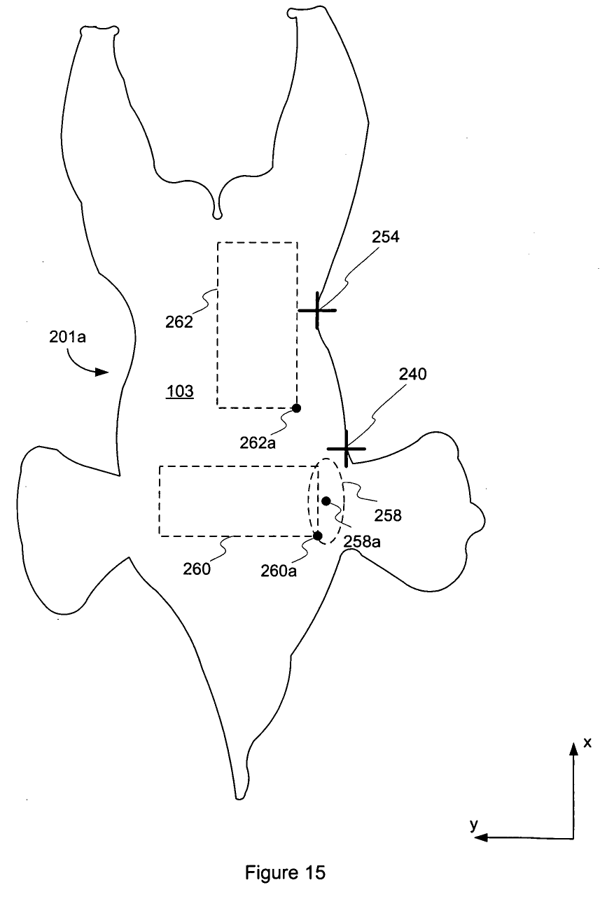

A possible algorithm for the detection of the presence of a skin condition that may be used at block 214 is depicted by the flow diagram shown in FIGS. 14A and 14B with reference to FIG. 15. The steps of the algorithm are indicated by blocks 372 to 406.

At block 372 the algorithm starts by setting a center detection window 260 anchor point 260a using the upper reference point 240 identified at block 316 of the wing detection algorithm. The anchor point 260a is set using predetermined x and y coordinate offsets. For example, assuming that the lower reference point 240 has coordinates (295, 165), the offsets may be (65, 25), resulting in anchor point 260a having coordinates (230, 190). It is to be understood that these offset values may vary depending on the application and the type of carcass being inspected.

At block 374, the center detection window 260 is positioned using anchor point 260a as the bottom right corner of a rectangle having dimensions of 70 pixels in the x axis, 110 pixels in the y axis. It is to be understood that these dimensions may vary depending on the application and the type of carcass being inspected.

At block 376, the algorithm computes the number of pixels with a color corresponding to a skin condition within center detection window 260 placed on the digital image 200. The “pixel counter” tool, in conjunction with a table of RGB values corresponding to colors associated with the skin condition, may be used to determine number of pixels with a color corresponding to the skin condition within center detection window 260.

Then, at block 378, the algorithm verifies if the number of pixels with a color corresponding to the skin condition is lower than 250 pixels. If not, the algorithm goes to block 380 were it registers that the skin condition is present and exits.

At block 382, the algorithm sets the side of the carcass 103 to be inspected to the right side. Then, at block 384, using the upper reference point 240 identified at block 316, the algorithm sets an upper side detection window 258 anchor point 258a. The anchor point 258a is set using predetermined x and y coordinate offsets. For example, assuming that the lower reference point 240 has coordinates (295, 165), the offsets may be (60, 15), resulting in anchor point 258a having coordinates (235, 180). It is to be understood that these offset values may vary depending on the application and the type of carcass being inspected.

At block 386, the upper side detection window 258 is positioned using anchor point 258a as the center of an ellipse having dimensions of 120 pixels in the x axis, 25 pixels in the y axis. It is to be understood that these dimensions may vary depending on the application and the type of carcass being inspected.

At block 388, the algorithm computes the number of pixels with a color corresponding to the skin condition within upper side detection window 258 placed on the digital image 200. The “pixel counter” tool, in conjunction with a table of RGB values corresponding to colors associated with the skin condition, may be used to determine number of pixels with a color corresponding to the skin condition within upper side detection window 258.

Then, at block 390, the algorithm verifies if the number of pixels with a color corresponding to the skin condition is lower than 330 pixels. If not, the algorithm goes to block 392 were it registers that the skin condition is present and exits.

At block 394, the algorithm sets a lower side detection window 262 anchor point 262a using the lower reference point 254 identified at block 354 of the hole detection algorithm. The anchor point 262a is set using predetermined x and y coordinate offsets. For example, assuming that the lower reference point 254 has coordinates (370, 160), the offsets may be (100, 15), resulting in anchor point 262a having coordinates (270, 175). It is to be understood that these offset values may vary depending on the application and the type of carcass being inspected.

At block 396, the lower side detection window 262 is positioned using anchor point 262a as the bottom right corner of a rectangle having dimensions of 165 pixels in the x axis, 75 pixels in the y axis. It is to be understood that these dimensions may vary depending on the application and the type of carcass being inspected.

At block 398, the algorithm computes the number of pixels with a color corresponding to the skin condition within center detection window 262 placed on the digital image 200. The “pixel counter” tool, in conjunction with a table of RGB values corresponding to colors associated with the skin condition, may be used to determine number of pixels with a color corresponding to the skin condition within center detection window 262.

Then, at block 400, the algorithm verifies if the number of pixels with a color corresponding to the skin condition is lower than 353 pixels. If not, the algorithm goes to block 402 were it registers that the skin condition is present and exits.

At block 404, the algorithm verifies if the left side of the high contrast image 201 has been inspected. If not, at block 406, the algorithm sets the side of the carcass 103 to be inspected to the left side and goes back to block 384. If both sides of the carcass 103 have been inspected, the algorithm exits.

It is to be understood that various skin conditions may be detected, each skin condition having a table of RGB values corresponding to colors associated with the skin condition. Examples of skin conditions may be the presence of flesh, i.e. areas where the skin is missing, or redness of the skin.

Presence of Flesh

RGB values corresponding to colors associated with the presence of flesh may be predetermined by taking digital images of flesh and registering the ranges of RGB values within a table. Table 1 gives an example of RGB values that may be used for poultry breast flesh colors. It is to be understood that the range of flesh color RGB values may vary with the type carcass, lighting conditions, body part, etc.

TABLE 1
RGB values for poultry breast flesh colors

| Color number | Red component | Green component | Blue component |
|---|---|---|---|
| 1 | 28.2 to 34.1 | 7.8 to 10.6 | 6.3 to 10.6 |
| 2 | 25.1 to 34.1 | 6.3 to 9.0 | 6.3 to 9.0 |
| 3 | 28.2 to 37.3 | 6.3 to 9.0 | 6.3 to 12.2 |
| 4 | 28.2 to 31.0 | 9.4 to 12.2 | 0.0 to 5.9 |
| 5 | 28.2 to 34.1 | 9.4 to 12.2 | 0.0 to 5.9 |
| 6 | 31.4 to 34.1 | 12.5 to 13.7 | 6.3 to 9.0 |
| 7 | 31.4 to 34.1 | 9.4 to 12.2 | 6.3 to 9.0 |
| 8 | 25.1 to 27.8 | 7.8 to 9.0 | 0.0 to 5.9 |
| 9 | 25.1 to 27.8 | 6.3 to 7.5 | 0.0 to 5.9 |
| 10 | 31.4 to 34.1 | 0.0 to 9.0 | 3.1 to 9.0 |
| 11 | 31.4 to 37.3 | 11.0 to 12.2 | 3.1 to 9.0 |
| 12 | 37.6 to 43.5 | 9.4 to 12.2 | 0.0 to 5.9 |
| 13 | 40.8 to 43.5 | 14.1 to 18.4 | 3.1 to 9.0 |
| 14 | 34.5 to 43.5 | 3.1 to 7.5 | 0.0 to 9.0 |
| 15 | 43.9 to 49.8 | 12.5 to 16.9 | 3.1 to 12.2 |
| 16 | 40.8 to 46.7 | 9.4 to 12.2 | 0.0 to 9.0 |
| 17 | 15.7 to 21.6 | 6.3 to 10.6 | 0.0 to 9.0 |

Redness of the Skin

RGB values corresponding to colors associated redness of the skin may be predetermined by taking digital images of redness and registering the ranges or RGB values within a table. Table 2 gives an example of RGB values that may be used for poultry breast redness colors. It is to be understood that the range of redness color RGB values may vary with the type carcass, lighting conditions, body part, etc.

TABLE 2
RGB values for poultry breast redness colors

| Color number | Red component | Green component | Blue component |
|---|---|---|---|
| 1 | 31.4 to 37.3 | 11.0 to 12.2 | 3.1 to 9.0 |
| 2 | 37.6 to 43.5 | 9.4 to 12.2 | 0.0 to 5.9 |
| 3 | 40.8 to 43.5 | 14.1 to 18.4 | 3.1 to 9.0 |
| 4 | 34.5 to 43.5 | 3.1 to 7.5 | 0.0 to 9.0 |
| 5 | 43.9 to 49.8 | 12.5 to 16.9 | 3.1 to 12.2 |
| 6 | 40.8 to 46.7 | 9.4 to 12.2 | 0.0 to 9.0 |
| 7 | 15.7 to 21.6 | 6.3 to 10.6 | 0.0 to 9.0 |

It is to be understood that the various values for the pixel thresholds and windows dimensions are based on the size of the digital image, which is 640 by 480 pixels in the example embodiment, the type of carcass being inspected and the specific inspection criteria. The specified values are meant as examples only and other values may be used depending on the application and quality levels.

Although the present invention has been described by way of a particular embodiment and examples thereof, it should be noted that it will be apparent to persons skilled in the art that modifications may be applied to the present particular embodiment without departing from the scope of the present invention.

What is claimed is:

1. A method for classifying a meat carcass, comprising the steps of:
a. acquiring at least one digital image of the carcass;
b. processing the digital image;
c. verifying the processed digital image in order to detect the presence of at least one defect;
d. classifying the carcass in response to the presence or not of the at least one defect.

2. A method for classifying a meat carcass according to claim 1, further comprising the step of
e. activating an output associated with the classification of the carcass effected in step d.

3. A method for classifying a meat carcass according to claim 1, wherein the at least one digital image is a 640 by 480 pixel digital image.

4. A method for classifying a meat carcass according to claim 1, wherein the step of processing the digital image comprises the steps of:
i. applying an enhancement filter to the digital image;
ii. transforming the enhancement digital image to grayscale;
iii. applying a threshold filter to the grayscale image;
iv. applying an unrelated structure filter.

5. A method for classifying a meat carcass according to claim 3, wherein the enhancement filter consist in applying a gain to the red component of the RGB values of the digital image.

6. A method for classifying a meat carcass according to claim 3, wherein the threshold filter consist in applying a luminosity threshold.

7. A method for classifying a meat carcass according to claim 6, wherein the threshold is set at 41%.

8. A method for classifying a meat carcass according to claim 3, wherein the unrelated structure filter consist in eliminating any structure composed of less than 50,000 pixels.

9. A method for classifying a meat carcass according to claim 1, wherein one of the at least one defect is the absence of a carcass.

10. A method for classifying a meat carcass according to claim 9, wherein the step of verifying the processed digital image in order to detect the absence of a carcass consists in detecting a structure having a predetermined number of pixels.

11. A method for classifying a meat carcass according to claim 10, wherein the number of pixels is 50,000.

12. A method for classifying a meat carcass according to claim 1, wherein one of the at least one defect is the absence of a leg.

13. A method for classifying a meat carcass according to claim 12, wherein the step of verifying the processed digital image in order to detect the absence of a leg consists in detecting contrast changes along a line applied to the processed digital image.

14. A method for classifying a meat carcass according to claim 1, wherein one of the at least one defect is the absence of a wing.

15. A method for classifying a meat carcass according to claim 14, wherein the step of verifying the processed digital image in order to detect the absence of a wing comprises the steps of:
i. estimating the length in pixels of the wing;
ii. verifying that the length of the wing is over a first threshold;
iii. estimating the width in pixels of the wing;
iv. verifying that the width of the wing is over a second threshold;
v. estimating the number of pixels of the wing;
vi. verifying that the number of pixels of the wing is over a third threshold.

16. A method for classifying a meat carcass according to claim 1, wherein one of the at least one defect is the presence of a hole in a leg.

17. A method for classifying a meat carcass according to claim 16, wherein the step of verifying the processed digital image in order to detect the presence of a hole in a leg comprises the steps of:
i. estimating the number of consecutive black colored pixels within a detection window;
ii. vi. verifying that the number of consecutive black colored pixels is below a fourth threshold.

18. A method for classifying a meat carcass according to claim 1, wherein one of the at least one defect is the presence of a skin condition.

19. A method for classifying a meat carcass according to claim 18, wherein the step of verifying the processed digital image in order to detect the presence of a skin condition comprises the steps of:
i. estimating the number of pixels having RGB values to colors associated with a skin condition within at least one detection window;
ii. vi. verifying that the number of pixels having RGB values to colors associated with a skin condition is below a fifth threshold.

20. A method for classifying a meat carcass according to claim 18, wherein the skin condition is selected from a group consisting of apparent flesh and redness of the skin.
